(19) United States
(12) Patent Application Publication
(10) Pub. No.: US 2026/0099475 A1
(43) Pub. Date: Apr. 9, 2026

(54) SYSTEMS AND METHODS FOR DETECTING TYPOGRAPHICAL ERRORS IN DOMAIN NAME ENTRIES

(71) Applicant: DNSFilter, Inc., Denver, CO (US)

(72) Inventor: David Elkind, Washington, DC (US)

(73) Assignee: DNSFilter, Inc., Denver, CO (US)

(21) Appl. No.: 19/347,861

(22) Filed: Oct. 2, 2025

Related U.S. Application Data
(60) Provisional application No. 63/703,558, filed on Oct. 4, 2024.

(51) Int. Cl. G06F 16/215; G06F 17/16

(52) U.S. Cl. CPC G06F 16/215; G06F 17/16

(57) ABSTRACT

Systems and methods for detecting a typographical error in a domain name, including: receiving a domain name comprising Unicode characters; encoding each character, where the encoding includes: computing an integer index of the Unicode characters; converting the integer index into a binary representation; and multiplying the binary representation by a dense matrix to obtain a floating-point vector; and comparing the floating-point vector to a reference floating-point vector of a known domain name using a model to determine if the domain name contains the typographical error.

### FIELD OF THE DISCLOSURE

The present disclosure relates to detection of typographical errors. In particular, but not by way of limitation, the present disclosure relates to the detection of typographical errors in entries of domain names in polyglot environments.

### REFERENCE TO RELATED APPLICATIONS

The present disclosure claims the benefit of US Prov. Pat. App. No. 63/703,558, filed on Oct. 4, 2024, and titled “System for detection of typographical errors in domain name entries and associated methods,” which is incorporated hereby in its entirety by reference.

### DESCRIPTION OF RELATED ART

Domain Name System (DNS) servers generally operate to translate domain names into IP addresses associated with specific websites. Like switchboard operators of bygone days, a DNS server receives a requested domain name as an entry from a user, who may type the domain name into a browser application, click a link in a message or a webpage, or other means to enter the known domain name information. The DNS server then translates the requested domain name information into an IP address, which then may be used to connect with a website.

### SUMMARY

These and other needs are addressed by the various embodiments and configurations of the present disclosure. The present disclosure is directed generally to detection of errors in domain names.

Various embodiments disclosed herein are directed to systems and methods for detecting a typographical error in a domain name, including: receiving a domain name comprising Unicode characters; encoding each character, where the encoding includes: computing an integer index of the Unicode characters; converting the integer index into a binary representation; and multiplying the binary representation by a dense matrix to obtain a floating-point vector; and comparing the floating-point vector to a reference floating-point vector of a known domain name using a model to determine if the domain name contains the typographical error.

The above-described embodiments and configurations are neither complete nor exhaustive. As will be appreciated, other embodiments of the invention are possible utilizing, alone or in combination, one or more of the features set forth above or described in detail herein.

### BRIEF DESCRIPTION OF DRAWINGS

FIG. 1 shows an illustrative DNS typographical error assessment system, in accordance with various embodiments disclosed herein.

FIG. 2 shows an illustrative assessment system, in accordance with various embodiments disclosed herein.

FIG. 3 shows an illustrative assessment process in accordance with various embodiments disclosed herein.

FIG. 4 shows an illustrative computer system for implementing aspects of the present disclosure, in accordance with various embodiments disclosed herein.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While some exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” or “computer-readable storage medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer-readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the herein, including in the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer readable signal medium or a computer-readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJS™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Various embodiments of the disclosure provide systems and methods for detecting typographical errors in domain name entries (also referred to as a domain name string, or simply a domain name). While the flowchart(s) herein will be discussed and illustrated in relation to a particular sequence of events, it should be appreciated that changes, additions, and omissions to this sequence can occur without materially affecting the operation of the disclosed embodiments, configuration, and aspects.

In general, DNS providers want to protect their customers against problems such as typosquatting attacks, which trick victims into navigating to domains crafted by attackers as part of a malicious scheme, such as phishing for personal information and inadvertent malware installation. In addition to misspellings (such as inserting or deleting a character, shuffling the middle characters), attackers might also replace a character in one alphabet with a similar or even identical look alike character from a different alphabet. Such intentional typographical errors may be difficult to detect, particularly in polyglot environments. For example, when one or more characters within a domain name string is intentionally replaced with a character from a foreign language, the shown domain name string may be visually indistinguishable from the intended domain name string to an unsophisticated user.

The fact that foreign language domain name strings are encoded as Punycode, which may appear to be a random string of text, adds another layer of complication. If an intentional typographical error is introduced, the two domain names may be visually indistinguishable, even though the two strings refer to entirely different DNS records (e.g., different websites or servers).

For example, domain names often use American Standard Code for Information Interchange (ASCII) characters. ASCII forms a subset of UTF-8. UTF-8 stands for Unicode Transformation Format – 8-bit; it is a character encoding method that represents any Unicode character using sequences of 1 to 4 bytes. When Punycode is used to render a non-ASCII domain name as a DNS record, the corresponding Punycode will generally begin with a “xn--” prefix and appear to be a set of random letters and numbers. If the Punycode corresponds to a legitimate domain name in a foreign language, the user’s computer may correctly display the foreign language domain name using UTF-8. That is, a typographical error intentionally introduced into the Punycode itself will likely break the encoding and not display correctly so as to be readily detectable by the user. However, a malicious attacker may instead create Punycode that renders in UTF-8 an incorrect domain name that looks at first glance like the intended, correct domain name, thus deceiving the user into proceeding to a fake website corresponding to the incorrect domain name. Such typosquatting attacks are difficult to detect using existing methods. Therefore, protective DNS needs an improved system and method that can understand the similarity between homoglyph characters and other kinds of distortions of domain names.

Some approaches for string similarity rely on edit distance metrics such as Levenshtein distance and similar variants. These are not ideal candidates for solving typosquatting because these approaches treat all characters atomically (e.g., Greek omicron is different from English o) and because humans do not generally visually perceive characters in a text string by edit distance. For example, while shuffling the middle characters within a given word can produce a large edit distance, a person in a hurry is unlikely to notice the shuffled letters. A low error rate, typo assessment tool that is closer to real-world conditions, reflective of the way humans input domain names into a web browser or other contexts, would be highly desirable.

Moreover, edit distance is too coarse to be useful in an industrial setting, such as for DNS typo assessment. For example, edit distance analysis has a high error rate (false negative and/or false positive) because it does not account for the human process that produces lookalikes or typos in the real world. Additionally, edit distance is expensive to compute at scale because of its computational complexity, computing the edit distance for two strings of length n has a computational cost that increases as a square of n. A linear-time comparison is desirable because it is a computationally faster process. For example, if each domain name is first converted to a vector representation where the vector has d elements, then the similarity of two domains can be measured as the cosine similarity. In the special case that the vectors have unit length, then the cosine similarity is given as the dot product of the vectors, which is computed in exactly d multiplications.

Another disadvantage of previously discussed methods is that they were generally developed for working with text strings and word clusters with intended meaning, such as for natural language processing and generative text. However, domain names are generally strings of seemingly random characters with no specific meaning. Therefore, improved typo assessment systems and methods specifically for assessing domain name strings would be desirable.

In some embodiments, a typographical error assessment process includes a specialized encoding scheme for receiving domain name data and constructing a vector representation of the domain name string in a compact and efficient manner. The assessment process further includes comparisons of similarity between domain strings. In embodiments, the vector representation is created using a neural network.

In various embodiments, the specialized encoding scheme includes constraining the dense matrix used in the specialized encoding scheme, so as to enforce uniqueness of the representation so generated.

In certain embodiments, the output of the dense matrix multiplication is normalized to enforce a condition that a vector has a specific length, thus ensure uniformity of data fed into the neural network.

In some aspects, the mutations used in training the neural network are generated “online” (i.e., during the training process itself, as opposed to establishing a fixed number of mutations before training begins) such that a vast majority of mutants seen by the model are unique.

In various embodiments, a typographical error (i.e., typo) assessment system includes an assessment server for receiving domain name data from a DNS server and one or more processors for performing machine readable instructions including a processing module, configured to encode the domain name data so received into a vector representation of the domain name data and assessing the similarity between the domain name data and a list of popular domains, which are presumed to be potential targets of a typosquatting attack. In certain embodiments, the processing module includes a neural network for performing the assessment, including turning a domain string into a vector representation. In embodiments the typo assessment system further includes a training module for training the neural network. In further embodiments, the assessment server includes electronic storage for storing at least one of previous assessment results, a lookup table, a database of mutations, among others.

Various embodiments include a system for detecting a typographical error in a domain name, including: a processor; a network interface to a network; and a memory comprising a set of instructions that, when executed by the processor, cause the processor to: receive a domain name comprising Unicode characters; encode each character, where the encoding includes: computing an integer index of the Unicode characters; converting the integer index into a binary representation; and multiplying the binary representation by a dense matrix to obtain a floating-point vector; and compare the floating-point vector to a reference floating-point vector of a known domain name using a model to determine if the domain name contains the typographical error.

In some aspects, the dense matrix is parameterized as orthonormal vectors. In various aspects, the floating-point vector and the reference floating-point vector are normalized to have unit length.

In some embodiments, the set of instructions further cause the processor to train the model by generating typos of known domain names each comprising a set of known characters, the known domain names comprise the known domain name, and the set of instructions further comprise encoding each of the known characters.

In various aspects, the generating typos of known domain names comprises inserting, duplicating, removing, and transposing a character in the known domain names. In further aspects, the model is a neural network engine. In still further aspects, the training comprises online training.

In various embodiments, the model is trained using the orthonormal vectors. In some embodiments, the floating-point vector and the reference floating-point vector are normalized to unit length, and where the comparing comprises determining a cosine similarity between the floating-point vector and the reference floating-point vector and comparing the cosine similarity to a threshold.

In some aspects, a result of the comparing the cosine similarity to the threshold is used to update a parameter for training the model. In further aspects, the comparing comprises O(d) comparisons of the cosine similarity.

Various embodiments disclosed herein include methods for detecting a typographical error in a domain name, including: receiving a domain name comprising Unicode characters; encoding each character, where the encoding includes: computing an integer index of the Unicode characters; converting the integer index into a binary representation; and multiplying the binary representation by a dense matrix to obtain a floating-point vector; and comparing the floating-point vector to a reference floating-point vector of a known domain name using a model to determine if the domain name contains the typographical error.

In some aspects, the dense matrix is parameterized as orthonormal vectors. In further aspects, the floating-point vector and the reference floating-point vector are normalized to have unit length. In various aspects, the set of instructions further cause the processor to train the model by generating typos of known domain names each comprising a set of known characters, the known domain names comprise the known domain name, and the set of instructions further comprise encoding each of the known characters.

In some embodiments, the generating typos of known domain names includes inserting, duplicating, removing and transposing a character in the known domain names. In certain aspects, the training comprises online training.

Various embodiments disclosed herein include computer program products, including: a non-transitory computer-readable storage medium having a computer-readable program code embodied therewith, the computer-readable program code configured, when executed by a processor, to: receive a domain name comprising Unicode characters; encode each character, where the encoding includes: computing an integer index of the Unicode characters; converting the integer index into a binary representation; and multiplying the binary representation by a dense matrix to obtain a floating-point vector; and compare the floating-point vector to a reference floating-point vector of a known domain name using a model to determine if the domain name contains the typographical error.

In various aspects, the dense matrix is parameterized as orthonormal vectors. In some aspects, the floating-point vector and the reference floating-point vector are normalized to have unit length.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, where like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a,’ ‘an,’ and ‘the’ include plural referents unless the context clearly dictates otherwise.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses.

The following detailed description is therefore not to be taken in a limiting sense, and the scope of the present disclosure is defined by the appended claims and their equivalents.

Domain name typographical error assessments are further complicated when all UTF-8 characters must be taken into consideration, such as in a polyglot environment. As a majority of domain names are represented by ASCII text, it is very rare to see many UTF-8 characters used within a domain name. However, as discussed herein, the potential replacement of a given ASCII character with a visually similar yet different UTF-8 character, particularly as used in polyglot environments, is a relatively easy way for a malicious party to redirect a web browser to a potentially harmful website.

Thus, DNS operators face an “Out of Vocabulary (OOV)” problem, namely, it is difficult to create a contextual representation for symbols that do not have any context in their corpus. One approach to overcoming the OOV problem is to assign any symbols that do not appear “often enough” (smaller number of occurrences than some researcher-selected threshold) in their corpus to a special OOV token. Naturally, this means that the model has no understanding of these rare or never-before-seen tokens, which limits the ability of the neural network to generalize to new data. In a worst-case scenario, two distinct domains might be entirely composed of OOV tokens, leaving the model no way to differentiate between them.

Moreover, the sheer size of the Unicode character set creates challenges for any neural network that needs to work with Unicode characters. This is because typical methods for creating character-level models require representing a character as a vector. Even when such vectors have relatively small numbers of elements, it can consume too much memory to be used in a memory-constrained setting (smartphone, embedded system, network appliance).

For example, consider that UTF-8 can represent 1,112,064 codepoints. One standard “rule of thumb” for choosing the number of elements in an embedding vector is the 4th root of the number of tokens you wish to represent, leading to 32 elements per vector. Consequently, the embedding matrix stores 35,586,048 single-precision float32 elements. Then, the total memory consumption is 142344192 bytes (using single-precision float32 and ignoring any overhead), which is about 135 MB of memory, solely to represent the raw characters that might be in a domain string. Handling such large amounts of data is cumbersome and impractical for DNS-related tasks, which rely on response times of milliseconds or less. Doing so in a memory-constrained environment is even more challenging.

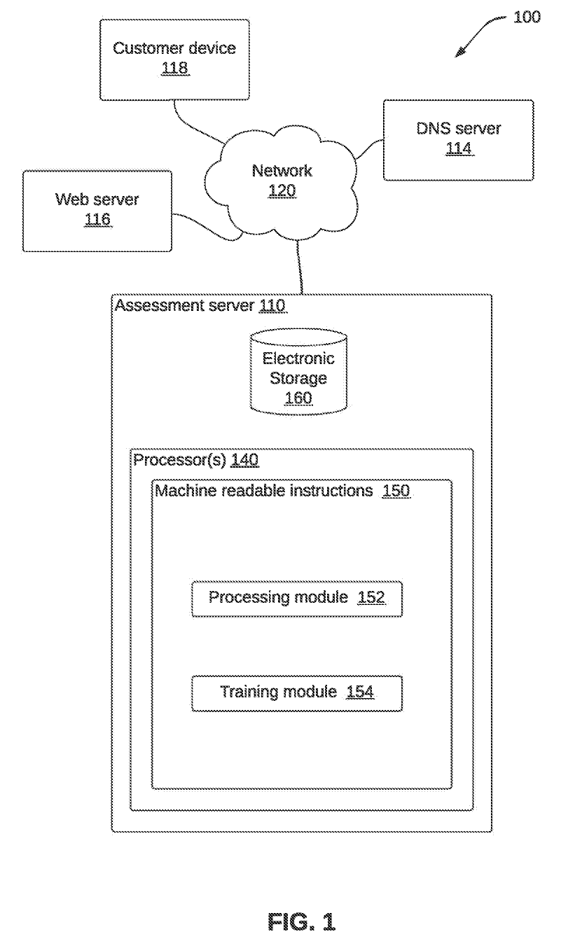

FIG. 1 shows an illustrative DNS typographical error assessment system, in accordance with various embodiments disclosed herein. In particular, FIG. 1 shows a system 100 configured for assessing and detecting typographical errors in domain name inputs. Domain names may be full or partial domain names. In certain implementations, system 100 may include an assessment server 110 configured to communicate with one or more of DNS server 114, web server 116, and customer device 118 via a network 120. In some embodiments, customer device 118 may be a communication device of a user, which may be a customer, administrator, or a user with any other role. While communicating (e.g., via network 120), data (not shown) may be sent and/or received via assessment server 110, data (not shown) may be sent and/or received via DNS server 114, data (not shown) may be sent and/or received via web server 116, and data (not shown) may be sent and/or received via customer device 118.

In various aspects, DNS 114 may be a computing device or server operated by a DNS provider, web server 116 may be a computing device or server on which one or more websites may be hosted, and customer device 118 may be a computing device operated by a customer attempting to access one of the websites hosted at web server 116.

Processor(s) 140 may comprise a processor or microprocessor. As used herein, the word processor may refer to a plurality of processors and/or microprocessors operating together. Processor(s) 140 may be capable of executing software and performing steps of methods as described herein. For example, processor(s) 140 may be configured to display user interfaces on a display of a computer device (e.g., customer device 118).

The assessment server 110 may comprise any type of computer device that can communicate on the network 120, such as a server, a Personal Computer (“PC”), a video phone, a video conferencing system, a cellular telephone, a Personal Digital Assistant (“PDA”), a tablet device, a notebook device, a smartphone, and/or the like. In some aspects, the assessment server 110 may be implemented as a single server or as multiple servers operating in a distributed or cloud-based configuration. In certain implementations, the assessment server 110 may be referred to as an assessment system that executes one or more software modules for processing input data, performing neural network inference, training, scoring, and related functions, as described herein.

In various embodiments, the assessment server 110 includes a processor 140. The processor 140 may be configured to execute machine-readable instructions 150, which in turn may include one or more functional modules. By way of example, the machine-readable instructions 150 may include a processing module 152 and a training module 154. In various aspects, the processing module 152 may itself include one or more subcomponents (not shown in FIG. 1) configured to perform operations such as encoding, dense matrix multiplication, vector normalization, inference, and scoring. In some embodiments, the neural network engine and its constituent components (e.g., inference layer, dense matrix module, normalization module, binary encoder, scoring module) may be implemented within the processing module 152. In alternative embodiments, one or more of these components may be implemented outside of the processing module 152 but remain accessible to the processor 140 and machine-readable instructions 150, including any neural network engine and associated components that is within the processing module 152. Thus, the architecture described herein and in FIG. 1 provides flexibility for distributing functionality between the processing module 152 and other elements of the assessment server 110.

In some embodiments, the training module 154, also illustrated in FIG. 1 within the machine-readable instructions 150, may be configured to perform training or retraining of a neural network engine by updating model parameters. In some embodiments, the training module 154 may be integrated with the processing module 152, while in other embodiments, the training module 154 may be implemented as a distinct functional module separate from the processing module 152.

In some aspects, the processor 140 may be further coupled to the electronic storage 160. The electronic storage 160 may be configured to store any type of data, including and not limited to training data, input data, neural network weights, configuration parameters, thresholds, and other data required for operation of the assessment server 110. In various embodiments, the electronic storage 160 may also store executable instructions that implement the processing module 152, training module 154, and associated system functions.

FIG. 1 illustrates that the assessment server 110 may include a processor 140 executing machine-readable instructions 150, where the instructions may implement a processing module 152, a training module 154, or both. The processing module 152 may optionally incorporate a neural network engine and its constituent subcomponents, or such subcomponents may be implemented as separate modules communicatively coupled to the processor 140. Similarly, the training module 154 may be integrated with the processing module 152 or may be implemented separately.

As an illustrative example, when a customer attempts to access a particular website by entering a domain name into customer device 118 (e.g., by typing a domain name into a browser application or by clicking a web link on a web page or within a messaging application), the domain name information may be processed by DNS server 114. DNS server then translates the domain name so entered into an IP address associated with a particular web server (e.g., web server 116). In this example as illustrated in FIG. 1, the IP address is then sent to assessment server 110 to assess whether the domain name associated with the IP address is possibly a typographical variation of another known domain name (e.g., a known domain name may be a valid and trustworthy domain rather than a malicious actor). In an embodiment, assessment server 110 may include, for example, one or more processors 140 configured for executing machine-readable instructions 150, and machine-readable instructions 150 may include a processing module 152 for performing the IP address assessment. In a further embodiment, machine-readable instructions may further include a training module 154 through which processing module 152 (or one or more of its components) may be trained for further refining the IP address assessment.

Assessment server 110 may further include electronic storage 160 that includes non-transitory storage media for electronically storing information therein. As an example, electronic storage 160 may include one or more of system storage provided integrally (e.g., in a substantially non-removable manner) with assessment server 110, removable storage (e.g., optically-readable, magnetically-readable, electrical charge-based, and/or solid state storage media) removably connectable with assessment server 110 such as via a port or a drive, and/or virtual storage resources (e.g., cloud storage). Electronic storage 160 may be configured to store any type of information, including and not limited to software algorithms, information provided to and from processor(s) 140, DNS server 114, web server 116, and/or customer device 118, look-up tables, thresholds, previous assessment results, and other information to enable assessment server 110 to perform functions as described herein.

It is noted that, in various embodiments, assessment server 110 may be directly and exclusively connected with a specific DNS server 114, rather than being connected via network 120. As shown in FIG. 1, assessment server 110 may be configured to provide assessment service to multiple DNS servers (not shown) connected via network 120. . These and other configurations are contemplated and considered a part of the present disclosure.

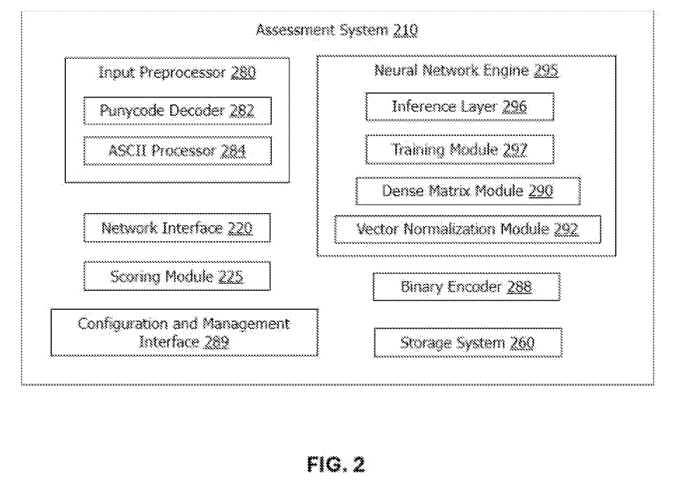

FIG. 2 shows an illustrative assessment system 210, in accordance with various embodiments disclosed herein. For example, FIG. 2 shows an assessment system 210 configured for assessing and detecting typographical errors in domain name inputs. In various embodiments, the systems and methods disclosed herein may be implemented with an assessment system instead of, or in addition to, an assessment server. In various aspects, the assessment system 210 may include a client (e.g., customer) device (not shown in FIG. 2), a storage system 260, and a network interface 220 that may collectively perform the assessment functions described herein, including those described in relation to an assessment server. In some embodiments, the assessment server and/or assessment system may be configured as a single computing device that integrates a processor (not shown in FIG. 2), storage (e.g., storage system 260), and communication modules (not shown in FIG. 2) to execute the assessment methods described herein. In further embodiments, the assessment system and/or assessment server may distribute these components across a plurality of devices, such as one or more servers, cloud-based resources, or specialized processing nodes. Thus, depending on the embodiment, the disclosed systems and methods may use a standalone assessment server, a broader assessment system including multiple cooperating devices, or a combination thereof.

In various embodiments, the assessment system 210 may be a dedicated computing platform, physical or virtualized, configured to execute the typographical error detection methods as described herein. The assessment system 210 can include one or more processors (not shown in FIG. 2) capable of performing high-throughput, parallelizable computations required for neural network inference and model training. The assessment system 210 can host an operating system and provide runtime environments for machine-readable instruction sets that implement the methods as described herein, including for example, modules for domain name encoding, vectorization, similarity scoring, and online model training.

Network interface 220 may enable the assessment system 210 to transmit and receive data packets over a network (not shown in FIG. 2). For example, in some aspects, network interface 220 may help facilitate communication with external servers and client devices (e.g., customer device 118). In further aspects, the network interface 220 may be implemented as a physical network interface card (NIC) or as a virtualized interface within a software-defined environment, and can support the exchange of DNS queries, Hypertext Transfer Protocol (Secure) (“HTTP(S)”) requests, and responses.

The input preprocessor 280 may receive domain-name strings from upstream sources, such as DNS servers or client applications and perform initial analysis of the input string's encoding, e.g., determining whether the string is formatted as ASCII and/or Punycode. In various aspects, for inputs identified as Punycode, the input preprocessor 280 can apply a Punycode decoding algorithm, using Punycode decoder 282 to convert the string into its corresponding Unicode representation (e.g., reconstruct the original Unicode code points). A Unicode code point is an integer that may be considered an index value that uniquely identifies the character in the Unicode standard. In various aspects, for inputs identified as ASCII, the input preprocessor 280 can verify that all characters conform to the ASCII character set and process the string as plain ASCII text. In some aspects, the input preprocessor 280 may compute an ord (e.g., a function that takes a character and returns its Unicode code point) to determine the integer code points (e.g., to create an integer index that corresponds to the domain name entry). In some aspects, instead of computing an ord, another indexing process may be used. Upon successful processing, the input preprocessor 280 can output an integer index of each Unicode code point, where the integer index uniquely identifies each input character from the domain name string. In various embodiments disclosed herein, because the integer index is created from Unicode code points, the integer index advantageously identifies and includes symbols (e.g., via the unique Unicode code point of the symbol) for OOV characters. The integer index that is output from the input preprocessor 280 may be provided to the binary encoder 288.

Binary encoder 288 may transform the integer index that is output by the input preprocessor 280 into a binary representation. For example, the integer value itself may be encoded such that each integer index is represented as a binary vector. In various embodiments, the binary vector includes unique information within the vector that corresponds to any OOV characters in the domain name entry. In various aspects, the binary encoder 288 processes each integer index into a fixed-width binary vector. In some embodiments, the binary vectors are output to the dense matrix module 290 of the neural network engine 295.

The neural network engine 295 may include a feed-forward neural network architecture, which may include one or more hidden layers, and can be designed to process input vectors corresponding to Unicode code points, including any Unicode code points for rare or OOV characters. The neural network engine 295 may receive a sequence of binary vectors corresponding to representations (also referred to as binary representations) derived from domain name strings. In various embodiments, dense matrix module 290 of the neural network engine 295 can receive the binary vectors (e.g., receive binary vector representations of Unicode code points that correspond to characters in a domain name string). In some embodiments, the dense matrix module 290 can multiply the binary representation by a learnable dense matrix (e.g., project each binary vector into a continuous vector space) to produce a floating-point representation.

In some embodiments, the dense matrix module 290 can parameterize the dense matrix such that its columns (or, in various embodiments, its rows) are constrained to be orthonormal, e.g., meaning that each column vector has unit length and is orthogonal to all other columns (or that each row vector has unit length and is orthogonal to all other rows). This orthonormality constraint can advantageously help ensure that each character is mapped to a unique, non-overlapping direction in the embedding space, thereby eliminating representational duplicates between different characters. Advantageously, by ensuring that all binary codes correspond to unique vectors such that all inputs to the network have distinct representation, no two characters will have the same dense representation and various embodiments of the neural network model described herein can be more descriptive of the input data, without the need for whitening the input data. The orthonormality constraint can also help facilitate more stable and rapid convergence during neural network training by decorrelating the input features and maintaining uniform variance across all character embeddings, e.g., to form a basis.

Further, enforcing the orthonormality of the binary projection matrix has additional advantages of speeding up training and suppressing “spiky” loss values due to rare tokens. For example, for the specific problem of typographical error detection in domain names for the full UTF-8 set of characters, rare UTF-8 characters can create transient spikes in the loss values during analysis. While such spikes can be handled by making sporadic updates to the early layers of the neural network, such procedures can cause large changes to inputs to the subsequent layers of the neural network, thus worsening the fit and requiring additional steps for the neural network to recover from the updates. However, in various aspects disclosed herein, by enforcing an orthogonality constraint to the dense matrix, the spike behavior is suppressed as altering any value in a dense, orthogonal matrix also updates other values, even if those values correspond to inputs that did not appear in the previous batch of inputs. That is, instead of suddenly making a large update to the few values that are particular to a rare character, at least some (up to all) of the values of the dense matrix may be updated at each iteration as changing one value of an orthonormal matrix updates all of the other values in the matrix. In this way, in various embodiments, the appearance of rare characters within the domain name does not disrupt the optimization process of the neural network.

The dense matrix module 290 may implement the orthonormality constraint using various techniques; for example, by parameterizing the matrix as a product of orthogonal matrices. Illustrative examples of techniques that can be used to implement the orthonormality constraint include and are not limited to Gram-Schmidt Orthogonalization, and QR decomposition methods, among others. The output of the dense matrix module 290 are vectors that, may be provided to the vector normalization module 292.

In some embodiments, the vector normalization module 292 may receive the output vectors produced by the dense matrix module 290. In some aspects, in the output vectors, each vector represents a character in the processed domain name string. The vector normalization module 292 may normalize the floating-point representations (e.g., floating-point vectors) to unit length. For example, the floating-point vectors may be rescaled so that the magnitude (e.g., length, measured with the Euclidean norm) equals a same number (in some aspects the same number is 1), while keeping its direction unchanged In other words, the vector normalization module 292 may apply a normalization operation to each vector such that the resulting vector has a unit (L2) norm, e.g., the Euclidean length of each vector may be scaled to one.

In some advantageous aspects, this normalization can help ensure that all character embeddings output from the vector normalization module 292 are on a consistent scale, regardless of the original magnitude of the output from the dense matrix module 290. In some aspects, by constraining the length of each character vector, the vector normalization module 292 can advantageously reduce the impact of characters that may otherwise cause large fluctuations in the input distribution. Such large fluctuations can be problematic because, for example, they can lead to unstable gradients or inefficient optimization during neural network training. Thus, in various aspects, normalization by dividing each vector by its own L2 norm, computed as the square root of the sum of the squares of its elements, may be advantageous. In various aspects, after normalization, the floating-point representations are vectors having the same length while keeping the directions that each vector points in unchanged.

In some embodiments, the output of the vector normalization module 292 may be a set of floating-point vectors, with the floating-point vectors corresponding to characters in the input string, including rare and OOV characters. Advantageously, the floating-point vectors as described herein may be compact and efficient, enabling fast lookups and comparisons. For example, in various embodiments, the vector normalization module 292 may aggregate vector inputs into a fixed-length embedding that characterizes the entire domain name, thus advantageously facilitating more efficient, memory-constrained, and scalable encoding of full Unicode character sets (e.g., an entire Unicode character set representing a domain name) for use in typographical error assessment of domain names. Various advantages of using the normalized vectors as disclosed herein include, for example, improved ease of comparability (e.g., because scale differences are removed), cosine similarity (e.g., the dot product is equal to the cosine of the angle between them), stability in training (e.g., by ensuring consistent magnitudes), and improvement of comparisons due to the normalized embeddings that ensures that comparisons can be based on direction and relationship (e.g., not on arbitrary lengths). Further, advantageously the neural network may achieve better results by decorrelating the inputs in addition to applying zero mean and unit variances. The use of a constrained dense matrix and vector norm constraint can enable online neural net model training, improved speed of training, and fast optimization of the analysis results, all of which were heretofore unavailable using existing methods for domain name typographical error detection.

In various aspects, the binary encoding scheme is the sum of k orthonormal vectors, where k is the number of bits in the encoding, the binary projection matrix outputs have length k, with the value of k being variable among characters according to the ord of the input. Having inputs to a neural network on a common scale can improve the speed of training, such as using whitening procedures, normalizing the resulting vectors such that every vector has a length of one can advantageously be particularly powerful in improving the optimization efficiency in the embodiments described herein.

When used in combination with the dense matrix orthogonality constraint described above, normalization of the resulting vectors is helpful because only vector direction needs to be considered. That is, rather than each UTF-8 character being characterized by a length and a direction, normalization restricts all lengths to unity and each UTF-8 character is represented by a unique direction. Under this normalization constraint, increasing the magnitude value of any one of the vectors necessarily decreases the magnitude value of the other vectors. Accordingly, weights do not have to increase or decrease to offset an embedding vector that grows or diminishes in length during the training process.

Such length-constraining normalization of the vectors internal to the neural network processing enables highly efficient optimization of the neural network analysis for the specific problem in the presence of rare characters in large datasets, such as for typographical error detection in domain names represented by UTF-8 characters including high variance in the use frequency of the characters.

The output from the vector normalization module 292 may advantageously be compatible with various neural network types, including but not limited to multi-layer perceptrons (MLP), convolutional neural networks (CNN), recurrent neural networks (RNN), gated recurrent units (GRU), long short-term memory (LSTM) networks, Various embodiments of the present disclosure may use other neural network types in the methods and systems described herein.

In various embodiments, training module 297 may perform training of the neural network model used for typographical error assessment in domain name strings. In various embodiments, the training module 297 can perform online training by generating mutated domain name variants that are used as input to optimize the network's parameters. In some aspects, the online training is used instead of relying on a fixed set of precomputed mutations. The training module 297 may denote a first mutation of domain name x as 𝑓𝑓(𝑥𝑥)₁, a second mutation of the domain name may be denoted as 𝑓𝑓(𝑥𝑥)₂, etc. A similar process may be repeated for a distinct domain name y. The model may then be trained to maximize a particular parameter (e.g., cosine similarity) between 𝑓𝑓(𝑥𝑥)₁ and 𝑓𝑓(𝑥𝑥)₂ (and likewise 𝑓𝑓(𝑦𝑦)₁ and 𝑓𝑓(𝑦𝑦)₂, etc.) while minimizing the parameter between 𝑓𝑓(𝑥𝑥)₁ and 𝑓𝑓(𝑦𝑦)₁ as well as 𝑓𝑓(𝑥𝑥)₁ and 𝑓𝑓(𝑦𝑦)₂. Similar variations for other mutations for each input (e.g., 𝑓𝑓(𝑥𝑥)₁, 𝑓𝑓(𝑥𝑥)₂, 𝑓𝑓(𝑥𝑥)₃, … 𝑓𝑓(𝑥𝑥)_{𝑛𝑛}) may be contemplated, with a general aim of obtaining high similarity among pairs of mutant x values, with low similarity between pairs of mutant xvalues and mutant y values. In various aspects, several such mutations could be generated for each input.

In some embodiments, training module 297 may use circle loss methods and systems in the training. For example, the model may be trained with a pairwise loss function that emphasizes a circular decision boundary for similarity scores, and this may be used instead of a multi-similarity loss (which combines multiple similarity measures for training). This substitution can advantageously improve training dynamics by better distinguishing between similar and dissimilar domain name embeddings, thereby enhancing the overall accuracy and performance of the systems and methods described herein.

Advantageously, an on-the-fly, online approach to the training can enable tailored training of the neural network model for each specific domain name string being considered. That is, in various aspects, by generating the domain name mutations during the training process itself, the training process may be flexibly adjusted for a given domain name string. For example, certain domain names including long strings of characters or including known characters that are frequently targeted in typosquatting attacks may require the generation of a larger number of mutant domains during the training as compared to shorter domain names without frequently targeted characters. This is possible using the systems and methods described herein. In various embodiments, the goal may remain a desire for high similarity among the pairs of mutant xs but low similarity between pairs of mutant xs and mutant ys.

In some embodiments, an objective of training module 297 may be to maximize the similarity between embeddings of visually similar domain names (including those with homoglyph substitutions, character insertions, deletions, or transpositions) and to minimize the similarity between embeddings of visually dissimilar domain names. The use of normalized, fixed-length input vectors may advantageously advance this objective. In various aspects, the training module 297 can operate asynchronously with respect to inference and can be implemented as a background process on the assessment system 210, e.g., utilizing available computational resources without impacting the latency of domain name similarity assessments as described herein.

Inference layer 296 may receive floating-point vectors from the vector normalization module 292. In various embodiments, inference layer 296 may apply transformations (e.g., a linear transformation), functions (e.g., a nonlinear activation function), and other neural operations to produce the output that may be used as the prediction or decision of the model (e.g., the prediction or decision from the neural network engine 295). For example, inference layer 296 may map learned representations of the neural network engine 295 using cosine similarity between a normalized floating-point vector and one or more stored or generated reference vectors. The learned representations may thereby identify classifications or matches. In some embodiments, the inference layer 296 may determine similarity scores, class probabilities, or other evaluative metrics, and these may be output to a scoring module 225.

The scoring module 225 may evaluate output from the inference layer 296. For example, the scoring module 225 may process the degree of similarity between a vector representation of an input domain name and one or more reference vectors corresponding to known domain names. In some aspects, the scoring module 225 can receive as input a fixed-length, normalized floating-point vector. The scoring module 225 can also access a database or memory structure (e.g., storage system 260) containing precomputed or dynamically generated reference vectors for comparison. The scoring module 225 can compute a similarity metric between the input floating-point vector and the one or more reference vectors. In various embodiments, the similarity metric is a cosine similarity, defined as the dot product of two unit-length vectors, which yields a scalar value in the range [-1, 1]. For domain vectors that are explicitly normalized to unit length, the cosine similarity reduces to a direct dot product operation, enabling efficient computation in linear time with respect to the vector dimensionality. The scoring module 225 may also support alternative similarity metrics.

In various embodiments, the scoring module 225 may apply a configurable threshold to the computed similarity scores. In some aspects, the threshold may be configured using configuration and management interface 289. For example, the assessment system 210 may determine an output (e.g., a result) by comparing a floating-point vector generated by the neural network engine 295 to a reference floating-point vector corresponding to a correct or expected output (e.g., a floating-point vector corresponding to a known domain name). In various aspects, O(d) (e.g., a number of comparisons grows linearly with d, where d represents the dimension of the vectors) comparisons of similarity between domain strings (e.g., using floating-point vectors) may be performed, advantageously enabling faster lookups and comparisons and usage of more efficient vector databases. In some aspects, if the similarity (e.g., the cosine similarity) between the generated floating-point vector and any reference floating-point vector exceeds the threshold, the scoring module 225 can generate an output signal (e.g., a notification), and the output signal may include, for example, metadata such as the identity of the matched reference domain, the computed similarity score, and contextual information (e.g., timestamp, source of the query, risk assessment level, etc.). In certain aspects, the threshold value is configurable and can be set by a user (e.g., an operator or an administrator) or dynamically adjusted based on operational requirements. Adjustments may be made based on any criteria, including using operational requirements such as desired false positive or false negative rates.

Storage system 260 may be a non-volatile memory component configured to persistently store digital information required for the operation and optimization of the assessment system 210. In some aspects, the storage system 260 may be capable of maintaining model checkpoints, which are serialized states of the neural network or other machine learning models used in the systems and methods described herein. It may also store lookup tables, such as mappings between Unicode code points and their binary or dense matrix representations, and historical information. The storage system 260 may be implemented using a combination of high-speed, low-latency storage media (such as NVMe solid-state drives) for frequently accessed data, and scalable object storage (such as cloud-based or network-attached storage) for infrequently accessed data. The storage system 260 may support concurrent read and write operations to accommodate real-time assessment and continuous model training. It may expose interfaces for data backup, restoration, and secure deletion, and is configurable.

The configuration and management interface 289 may enable administrative interaction with the assessment system 210 and its components. In various aspects, the configuration and management interface 289 exposes programmatic endpoints to facilitate system configuration and operational management. For example, a user can adjust similarity threshold parameters that govern the sensitivity of results of the assessment system 210, configure information used in the assessment system 210, and control model training processes. The configuration and management interface 289 may support authentication and authorization mechanisms to restrict access to configuration functions. In some implementations, the configuration and management interface 289 can provide real-time feedback on configuration changes, log administrative actions, and expose endpoints for exporting or importing configuration states. The configuration and management interface 289 may be designed to operate in both local and remote deployment scenarios, supporting integration with external orchestration or monitoring systems. The configuration and management interface 289 may be implemented using industry-standard protocols and can be extended to support additional management operations as desired.

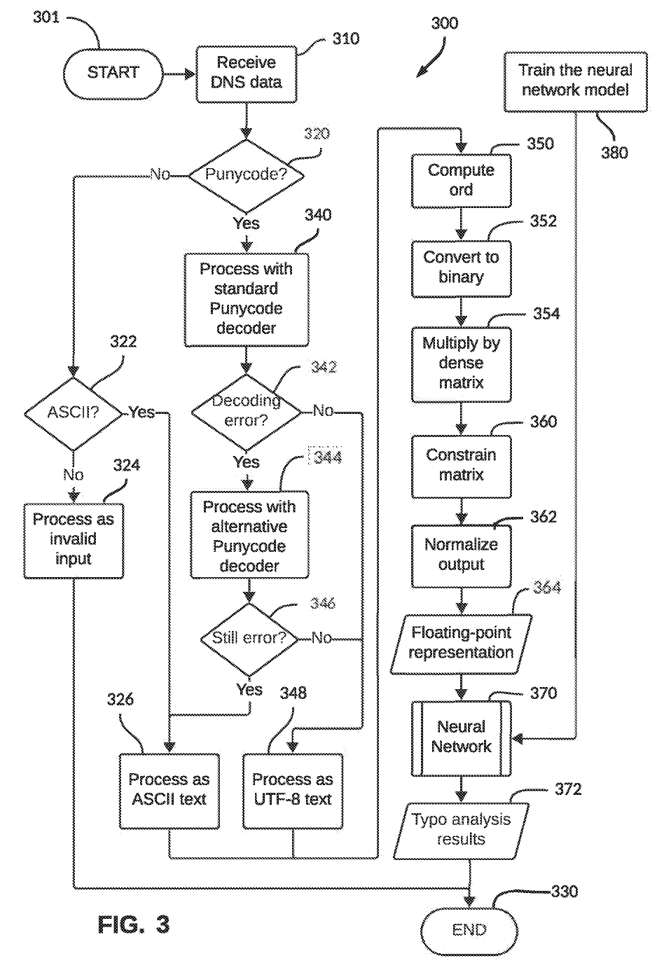

FIG. 3 shows an illustrative assessment process in accordance with various embodiments disclosed herein. Although the processes described herein may be shown in a specific order, the steps of systems and methods described herein may be implemented in different orders and/or be implemented in a multi-threaded environment. In addition, various steps may be omitted or added based on implementation.

In the illustrated example, an assessment process 300 begins with a start step 301, proceeding to a step 310 to receive DNS data at the assessment server. In some aspects, the DNS data may be received as part of a DNS resolution workflow. The received data may represent various encoding formats, including ASCII, Punycode, and/or UTF-8. The system may capture the domain name data regardless of the transport protocol (e.g., TCP, UDP) or network topology. In some embodiments, the step may include extracting the domain name string from a DNS query packet or from a resolved IP address mapping.

Assessment process 300 proceeds to determine the encoding format of the input string, distinguishing between Punycode, ASCII, and UTF-8 representations. For example, at decision step 320, a determination is made whether the DNS data received in step 310 corresponds to a Punycode. If the result of decision step 320 is NO, the DNS data is not Punycode, then assessment process 300 proceeds to a decision step 322 to determine whether the DNS data is instead in ASCII format. If the result of decision step 322 is NO, the DNS data is not in ASCII format, then the received data is processed as an invalid input at step 324. If decision step 322 determines that YES, the received data is indeed in ASCII format, then the received data is processed as ASCII text in a step 326. If the received DNS data is deemed invalid in step 324, then assessment process 300 is terminated in an End step 330.

Returning to decision step 320, if the result is YES, the received DNS data is Punycode, then the DNS data is processed (e.g., with a standard Punycode decoder) in a step 340. In some aspects, if the DNS data string is encoded in Punycode, the method decodes it to obtain the corresponding Unicode or UTF-8 string, and some embodiments may use various decoders (e.g., both standard and alternative Punycode decoders) to handle decoding errors.

In various embodiments, a determination is made in a decision step 342 whether step 340 resulted in a decoding error. If decision step 342 determines YES, there is decoding error, then assessment process 300 may proceed to an optional step 344 to process the DNS data with an alternative Punycode decoder. The alternative Punycode decoder may be, for example, a commercially available or custom Punycode decoder, different from the standard version used in step 340. If a determination is made in an optional decision step 346 that YES, a Punycode decoding error still exists, then assessment process 300 again proceeds to process the received DNS data as ASCII text in step 326.

If the result of decision step 342 is NO, there is no decoding error, then assessment process 300 proceeds to a step 348 to process the decoded output from step 340 as UTF-8 text. Similarly, if the processing with the optional, alternative Punycode decoder results in error-free decoding such that the result of optional decision step 346 is NO, there is no decoding error, then the decoded output from optional step 344 is directed to step 348 to be processed as UTF- 8 text.

The processed output from steps 326 (ASCII text) and 328 (UTF-8 text) are directed to a series of encoding steps to compactly represent the UTF-8 characters. The resulting encoded string is then fed into a feedforward neural network to produce a vector representation of all of the characters in the string, in which the vector has a fixed number of elements, which is then used to perform the typographical assessment.

Continuing to refer to FIG. 3, assessment process 300 proceeds to a step 350 to compute the ord of the ASCII and UTF-8 text provided from steps 326 and 348, respectively. In particular, the ord corresponds to a Unicode code point of a given input character, which can provide an integer index uniquely identifying the input character. For example, in various aspects, the system computes the Unicode code point (ord) for each character in the processed string.

The ord received from step 350 is converted into its binary representation in a step 352 (e.g., each code point is converted into a binary vector representation). Assessment process 300 proceeds to a step 354 to multiply the resulting binary representation (e.g., the binary vectors) with a dense matrix. For some dense matrices populated by random values drawn from any of a broad class of probability density functions, there is a high probability that this encoding scheme will uniquely represent every input, such as a domain name string. Advantageously, this uniqueness requirement may be enforced directly, rather than probabilistically, by constraining the admissible values of the dense matrix in a step 360. In embodiments, the constraining step includes parameterizing the dense matrix as orthonormal vectors to form a basis, as described herein, and when it is constrained to be orthonormal, this may advantageously ensure unique and decorrelated character representations.

Further, to additionally ensure the format uniformity of the inputs into a neural network assessment system, the output of the product of the binary matrix and the dense matrix is further normalized to a unit length in a step 362. Such normalization step is particularly useful in improving the optimization of the neural network assessment; for example, the normalization to unit length can advantageously produce a compact, fixed-dimensional floating-point representation of the domain-name string. In various embodiments, the result is a floating-point representation of the original DNS data, represented by data 364. The floating-point representation of data 364 is fed into a neural network 370, which has been trained to assess the similarity between domain-name strings so that the neural network 370 performs the assessment of the DNS data to produce typo analysis results, represented by data 372. For example, the neural network can output a similarity score, such as a cosine similarity, between the input domain and a set of reference domains (e.g., a list of known domains). The system may apply a configurable similarity threshold to determine whether the input string is classified as a plausible typographical variant (e.g. a typo) of any reference domain.

In various embodiments, the method may operate in linear time with respect to the number of characters in the input string, as transformations and neural network inference steps described herein may be designed for computational efficiency. The methods and systems may be optimized for deployment in memory-constrained environments, such as DNS appliances, by employing compact encoding schemes and avoiding large embedding matrices and graphical distortions that evade traditional edit-distance-based approaches. Assessment process 300 is then terminated in end step 330.

In some embodiments, the model used in neural network 370 for assessment process 300 is trained in a step 380. For instance, the model may be trained by providing “mutated” inputs generated from known domain names including procedurally generated typos by inserting, duplicating, removing, and transposing characters. The methods and systems can support online training of the neural network, generating mutated domain names during training to improve generalization and robustness to rare or out-of-vocabulary (OOV) characters. The methods and systems may be advantageously applicable to polyglot DNS environments and capable of detecting visually indistinguishable homoglyph attacks, Punycode-based lookalikes, and other typographical errors.

In certain embodiments, typos may be detected by neural network 370 by computing cosine similarity between pairs of domain names. In some aspects, a user (e.g., an administrator operating DNS server 114 of FIG. 1) may select a desired threshold of similarity to declare a match. If the cosine similarity of a given pair of floating-point vectors (e.g., a floating-point vector as described herein and a reference floating-point vector corresponding to a known domain) exceeds the desired threshold of similarity, then neural network 370 may conclude that a typographical error exists in the domain name corresponding to the floating-point vector.

In other words, the embodiments of the methods and systems described herein can include the following advantages over the existing art: a specialized encoding scheme is used to construct a vector representation of a domain name string in a compact and efficient manner; low-cost comparisons of similarity between domain strings may be performed, thus enabling fast lookups and/or comparisons and usage of more efficient vector database; and the mutations used in training the neural network may be generated “online” (e.g., based on known domain names) such that a vast majority of mutants seen by the model are unique. These advantages result in greatly improved typosquatting detection to enable the presently described systems and processes to be useful in industrial application.

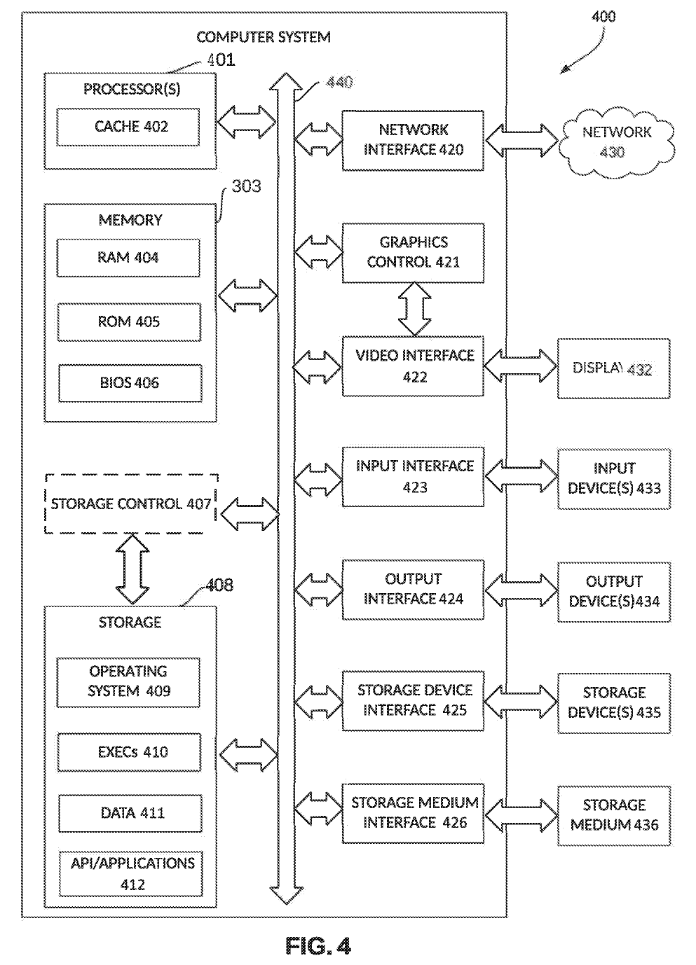

FIG. 4 shows an illustrative computer system for implementing aspects of the present disclosure, in accordance with various embodiments disclosed herein. In some aspects, FIG. 4 illustrates a diagrammatic representation of one embodiment of a computer system 400, within which a set of instructions can execute for causing a device to perform or execute any one or more of the aspects and/or methodologies of the present disclosure. The components in FIG. 4 are examples only and do not limit the scope of use or functionality of any hardware, software, firmware, embedded logic component, or a combination of two or more such components implementing particular embodiments of this disclosure. Some or all of the illustrated components can be part of the computer system 400. For instance, the computer system 400 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 400 includes at least a processor 401 such as a central processing unit (CPU) or a graphics processing unit (GPU) to name two non-limiting examples. Any of the subsystems described throughout this disclosure could embody the processor 401. The computer system 400 may also include a memory 403 and a storage 408, both communicating with each other, and with other components, via a bus 440. The bus 440 may also link a display 432, one or more input devices 433 (which may, for example, include a keypad, a keyboard, a mouse, a stylus, etc.), one or more output devices 434, one or more storage devices 435, and various non-transitory, tangible computer-readable storage media 436 with each other and/or with one or more of the processor 401, the memory 403, and the storage 408. All of these elements may interface directly or via one or more interfaces or adaptors to the bus 440. For instance, the various non-transitory, tangible computer-readable storage media 436 can interface with the bus 440 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 401 (or central processing unit(s) (CPU(s))) optionally contains a cache memory unit for temporary local storage of instructions, data, or computer addresses. Processor(s) 401 are configured to assist in execution of computer-readable instructions stored on at least one non-transitory, tangible computer-readable storage medium. Computer system 400 may provide functionality as a result of the processor(s) 401 executing software embodied in one or more non-transitory, tangible computer-readable storage media, such as memory 403, storage 408, storage devices 435, and/or storage medium 436 (e.g., read only memory (ROM)). Memory 403 may read the software from one or more other non-transitory, tangible computer- readable storage media (such as mass storage device(s) 435, 436) or from one or more other sources through a suitable interface, such as network interface 420. Any of the subsystems herein disclosed could include a network interface such as the network interface 420. The software may cause processor(s) 401 to carry out one or more processes or one or more steps of one or more processes described or illustrated herein. Carrying out such processes or steps may include defining data structures stored in memory 403 and modifying the data structures as directed by the software. In some embodiments, an FPGA can store instructions for carrying out functionality as described in this disclosure. In other embodiments, firmware includes instructions for carrying out functionality as described in this disclosure.

Memory 403 may include various components (e.g., non-transitory, tangible computer- readable storage media) including, but not limited to, a random-access memory component (e.g., RAM 404) (e.g., a static RAM "SRAM,” a dynamic RAM "DRAM, etc.), a read-only component (e.g., ROM 405), and any combinations thereof. ROM 405 may act to communicate data and instructions unidirectionally to processor(s) 401, and RAM 404 may act to communicate data and instructions bidirectionally with processor(s) 401. ROM 405 and RAM 404 may include any suitable non-transitory, tangible computer-readable storage media. In some instances, ROM 405 and RAM 404 include non-transitory, tangible computer-readable storage media for carrying out a method. In one example, a basic input/output system 406 (BIOS), including basic routines that help to transfer information between elements within computer system 400, such as during start-up, may be stored in the memory 403.

Fixed storage 408 is connected bi-directionally to processor(s) 401, optionally through storage control unit 407. Fixed storage 408 provides additional data storage capacity and may also include any suitable non-transitory, tangible computer-readable media described herein. Storage 408 may be used to store operating system 409, EXECs 410 (executables), data 411, API applications 412 (application programs), and the like. Often, although not always, storage 408 is a secondary storage medium (such as a hard disk) that is slower than primary storage (e.g., memory 403). Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with computer system 400 (e.g., via an external port connector (not shown)) via a storage device interface 425. Particularly, storage device(s) 435 and an associated machine-readable medium may provide nonvolatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 400 may also include an input device 433. In one example, a user of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof.

Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, such as mobile devices and enterprise systems, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 430, may employ a wired and/or a wireless mode of communication. In general, any network topology may be used.

Information and data can be displayed through a display 432. Examples of a display 432 include, but are not limited to, a liquid crystal display (LCD), an organic liquid crystal display (OLED), a cathode ray tube (CRT), a plasma display, and any combinations thereof. The display 432 can interface to the processor(s) 401, memory 403, and fixed storage 408, as well as other devices, such as input device(s) 433, via the bus 440. The display 432 is linked to the bus 440 via a video interface 422, and transport of data between the display 432 and the bus 440 can be controlled via the graphics control 421.

In addition to a display 432, computer system 400 may include one or more other peripheral output devices 434 including, but not limited to, an audio speaker, a printer, a check or receipt printer, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof.

In addition, or as an alternative, computer system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non- transitory, tangible computer-readable storage medium known in the art. An exemplary non- transitory, tangible computer-readable storage medium is coupled to the processor such that the processor can read information from, and write information to, the non-transitory, tangible computer-readable storage medium. In the alternative, the non-transitory, tangible computer- readable storage medium may be integral to the processor. The processor and the non- transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 400 shown in FIG. 4 such as, but not limited to, the network 430, processor 401, memory, 403, etc., may include a cloud computing system. In one such system, front-end systems such as input devices 433 may provide information to back-end platforms such as servers (e.g. computer systems 400) and storage (e.g., memory 403).

Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms, even if only the function or result is the same. Such equivalent, broader, or even more generic terms should be considered to be encompassed in the description of each element or action. Such terms can be substituted where desired to make explicit the implicitly broad coverage to which this disclosure is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding,” whether explicitly discussed or not, and, conversely, were there only disclosure of the act of “protruding,” such a disclosure should be understood to encompass disclosure of a “protrusion.” Such changes and alternative terms are to be understood to be explicitly included in the description.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms, even if only the function or result is the same. Such equivalent, broader, or even more generic terms should be considered to be encompassed in the description of each element or action. Such terms can be substituted where desired to make explicit the implicitly broad coverage to which this disclosure is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding,” whether explicitly discussed or not, and, conversely, were there only disclosure of the act of “protruding,” such a disclosure should be understood to encompass disclosure of a “protrusion.” Such changes and alternative terms are to be understood to be explicitly included in the description.

What is claimed is:

1. A system for detecting a typographical error in a domain name, comprising:
a processor;
a network interface to a network; and
a memory comprising a set of instructions that, when executed by the processor, cause the processor to:
receive a domain name comprising Unicode characters;
encode each character, wherein the encoding comprises:
computing an integer index of the Unicode characters;
converting the integer index into a binary representation; and
multiplying the binary representation by a dense matrix to obtain a floating-point vector; and
compare the floating-point vector to a reference floating-point vector of a known domain name using a model to determine if the domain name contains the typographical error.

2. The system of claim 1, wherein the dense matrix is parameterized as orthonormal vectors.

3. The system of claim 1, wherein the floating-point vector and the reference floating-point vector are normalized to have unit length.

4. The system of claim 1, wherein the set of instructions further cause the processor to train the model by generating typos of known domain names each comprising a set of known characters, wherein the known domain names comprise the known domain name, and wherein the set of instructions further comprise encoding each of the known characters in the set of known characters.

5. The system of claim 4, wherein the generating typos of known domain names comprises inserting, duplicating, removing and transposing a character in the known domain names.

6. The system of claim 4, wherein the model is a neural network engine.

7. The system of claim 6, wherein the training comprises online training.

8. The system of claim 2, wherein the model is trained using the orthonormal vectors.

9. The system of claim 2, wherein the floating-point vector and the reference floating-point vector are normalized to unit length, and wherein the comparing comprises determining a cosine similarity between the floating-point vector and the reference floating-point vector and comparing the cosine similarity to a threshold.

10. The system of claim 9, wherein a result of the comparing the cosine similarity to the threshold is used to update a parameter for training the model.

11. The system of claim 9, wherein the comparing comprises O(d) comparisons of the cosine similarity.

12. A method for detecting a typographical error in a domain name, comprising:
receiving a domain name comprising Unicode characters;
encoding each character, wherein the encoding comprises:
computing an integer index of the Unicode characters;
converting the integer index into a binary representation; and
multiplying the binary representation by a dense matrix to obtain a floating-point vector; and
comparing the floating-point vector to a reference floating-point vector of a known domain name using a model to determine if the domain name contains the typographical error.

13. The method of claim 12, wherein the dense matrix is parameterized as orthonormal vectors.

14. The method of claim 13, wherein the floating-point vector and the reference floating-point vector are normalized to have unit length.

15. The method of claim 12, further comprising training the model by generating typos of known domain names each comprising a set of known characters, wherein the known domain names comprise the known domain name, and further comprising encoding each of the known characters in the set of known characters.

16. The method of claim 15, wherein the generating typos of known domain names comprises inserting, duplicating, removing and transposing a character in the known domain names.

17. The method of claim 15, wherein the training comprises online training.

18. A computer program product for detecting a typographical error in a domain name, comprising:
a non-transitory computer-readable storage medium having a computer-readable program code embodied therewith, the computer-readable program code configured, when executed by a processor, to:
receive a domain name comprising Unicode characters;
encode each character, wherein the encoding comprises:
computing an integer index of the Unicode characters;
converting the integer index into a binary representation; and
multiplying the binary representation by a dense matrix to obtain a floating-point vector; and
compare the floating-point vector to a reference floating-point vector of a known domain name using a model to determine if the domain name contains the typographical error.

19. The computer program product of claim 18, wherein the dense matrix is parameterized as orthonormal vectors.

20. The computer program product of claim 18, wherein the floating-point vector and the reference floating-point vector are normalized to have unit length.
